(19) United States
(12) Patent Application Publication
(10) Pub. No.: US 2003/0167175 A1
(43) Pub. Date: Sep. 4, 2003

(54) Method and system for generating new businesses

(76) Inventor: Silvio Salom, St Kilda (AU)

Correspondence Address: Aliki K. Collins, 215 Grove St., Newton, MA, 02466, US

(21) Appl. No.: 09/759,188

(22) Filed: Jan. 10, 2001

(51) Int. Cl. G06F 17/60

(52) U.S. Cl. 705/1

(57) ABSTRACT

A method of generating a new enterprise is based on forming a holding company that includes existing enterprises. Intellectual property (IP) assets are developed within the existing enterprises and are deposited in a common database owned by the holding company. New products and market opportunities are developed for at least one of the developed IP assets within at least one of the existing enterprises. The management team of the holding company together with the management teams of the existing enterprises decide whether to form a new enterprise based on the developed new products and market opportunities. After the decision is made to form a new enterprise financing is secured for the formation of the new enterprise, a management team is provided for managing said new enterprise and a new enterprise is formed.

### FIELD OF THE INVENTION

The present invention relates to a method and a system for generating new businesses, and more particularly to generating new businesses by reusing existing intellectual property assets.

### BACKGROUND OF THE INVENTION

There are currently several international conglomerate corporations that include a large number of business units located worldwide. Each business unit provides products and solutions to their clients in the form of hardware and software products, processes, tools, ideas, and methodologies. These products and solutions incorporate technological know-how termed “intellectual property” (IP) (also known as “intellectual property (IP) assets”). During a typical product and solution development program, each business unit generates large amounts of intellectual property and uses it once for a given product, client or market, after which time it remains unused. However, much of this intellectual property has the potential to be reused numerous times and maintains a market potential far beyond that of an individual product, a client or a specific market.

In some cases there is a central depository of IP assets within the corporate law department of the international conglomerate corporations. However, there is no consistent effort to utilize the IP assets alone or in combination with others in order to develop new products and services and to start new business ventures. Furthermore, the type and number of business units that are included within an international conglomerate are determined by criteria such as profitability, core competencies, strategic decisions and historical or managerial preferences. This limits the diversity of IP assets. Therefore, there is a need for a business process that utilizes existing IP assets within a group of diverse businesses.

Current systems for funding emerging businesses are limited to venture capital funding and business incubators. Venture capital funding is limited in its effectiveness by the fact that it involves separate investors subsidizing a series of business ventures. These business ventures typically have no relationship with one another and the investors provide no channels in which the supported companies can reuse and exploit synergies between IP assets and thus realize a greater market potential of their intellectual property. Business incubators generally offer nascent businesses investment assistance and technical resources but seldom provide methodologies geared toward product success. Like venture funding, incubators provide no means to leverage the value of new and existing intellectual property. There is a need for a repeatable process in which intellectual property is reused with the objectives of starting new business ventures and maximizing the value of existing businesses.

As described above, existing business models and funding strategies are not conducive to cooperation between companies. Companies need to engage in long lasting negotiations in order to form joint ventures. This process of forming joint ventures usually takes long time to realize. This circumstance leads to the accumulation of financial as well as intellectual resources within individual companies and there is no good way for leveraging these assets. There is a need for establishing an economic environment in which companies under common or related ownership engage in cooperative relationships.

### SUMMARY OF THE INVENTION

In general, in one aspect, the invention provides a method of generating a new enterprise. The method includes the steps of forming a holding company composed of existing enterprises, developing intellectual property (IP) assets within the existing enterprises, depositing the IP assets in a common database owned by the holding company, developing new products and market opportunities for at least one of the developed IP assets within at least one of the existing enterprises, deciding whether to form the new enterprise based on the developed new products and market opportunities for the at least one of IP assets. After the decision is made to form the new enterprise financing is secured for the formation of the new enterprise, management resources are provided for managing the new enterprise and the new enterprise is formed.

Implementations of this aspect of the invention may include one or more of the following features. The method may further include acquiring intellectual property assets from companies other than the holding company for developing new products and market opportunities. The holding company may include financial asset companies and the financial asset companies may provide the financing for the formation of the new enterprise. The financial asset companies may be banking institutions, venture capital firms, financial investment companies and private investors. The holding company may further include a management team providing the management resources to the new enterprise. The management team may include management consulting resources, legal resources, patent protection resources and start-up company management resources. The existing enterprises include at least one of agricultural companies, mining, construction, manufacturing, transportation, communications, utilities, retail trade, wholesale trade, banking institutions, financial service companies, business services, management consulting, information technology services, law firms, educational institutions, health organizations and government organizations. The step of deciding whether to form a new enterprise includes evaluating the ability of the new enterprise to generate $500 million annual revenues within a 10 year period; evaluating the ability of the new enterprise to generate $ one billion market capitalization within a 10 year period; and evaluating the ability of the new enterprise to generate positive cash flow. The method may further include establishing cooperative agreements between the holding company and product-to-market channel partners. The product-to-market channel partners may be national and international operating corporations. More than one new enterprise may be generated on a repeatable basis. The existing enterprises and the new enterprises may agree to cooperative arrangements regarding the IP assets that are contained in the common database as well as access to IP assets developed in the future. Relationships may be established between the holding company and academic institutions. Within the frame of these relationships the holding company may provide training opportunities to students of the academic institutions. The academic institutions may also grant academic degrees to employees and trainees of the holding company for scientific, business and technical development work performed in the holding company. A reward system may be utilized for reinforcing developing of intellectual property assets by personnel and enterprises of the holding company. Financing arrangements may be established for financing the new enterprise between the holding company and financial asset companies.

In general, in another aspect, the invention features a business system generating a new enterprise. The system includes a holding company composed of existing enterprises, intellectual property (IP) assets developed within the existing enterprises, an IP database contained within the holding company for depositing the IP assets, new product and new market development teams for developing new products and market opportunities for at least one of the developed IP assets within at least one of the existing enterprises, financial assets for financing the formation of the new enterprise and a management team for managing the new enterprise.

Implementations of this aspect of the invention may include one or more of the following features. The business system may further include a network system connecting the existing enterprises, holding company, IP database, financial assets new product development team, new market development team, management team and the new enterprise. The business system may further include intellectual property assets from companies other than the holding company for developing new products and market opportunities. The holding company may include financial asset companies and the financial asset companies may provide the financing for the formation of the new enterprise. The financial asset companies may be banking institutions, venture capital firms, financial investment companies and private investors. The holding company may further include a management team providing the management resources to the new enterprise. The management team may include management consulting resources, legal resources, patent protection resources and start-up company management resources. The existing enterprises include at least one of agricultural companies, mining, construction, manufacturing, transportation, communications, utilities, retail trade, wholesale trade, banking institutions, financial service companies, business services, management consulting, information technology services, law firms, educational institutions, health organizations and government organizations. The business system may further include cooperative agreements between the holding company and product-to-market channel partners. The product-to-market channel partners may be national and international operating corporations. More than one new enterprise may be generated on a repeatable basis. The existing enterprises and the new enterprises may agree to cooperative arrangements regarding the IP assets that are contained in the common database. Relationships may be established between the holding company and academic institutions. Within the frame of these relationships the holding company may provide training opportunities to students of the academic institutions. The academic institutions may also grant academic degrees to employees and trainees of the holding company for scientific, business and technical development work performed in the holding company. A reward system may be utilized for reinforcing developing of intellectual property assets by personnel and enterprises of the holding company. Financing arrangements may also be established for financing the new enterprise between the holding company and financial asset companies.

Among the advantages of this invention may be one or more of the following. It provides a repeatable intellectual property commercialization process. It reduces the financial risk by allowing one controlling organization to retain ownership of all intellectual property while providing appropriate ownership to each created enterprise. It reduces financial risk by utilizing a business filtering process in which intellectual property is marketed and monitored on a profit-and-loss level to assess viability before the intellectual property is spun out into a separate business. It creates an economic environment in which companies under common or related ownership engage in cooperative relationships. It utilizes external intellectual property relationships to acquire more additional intellectual property. It utilizes a temporary start-up management team to provide skilled management resources during the start-up phase of each business. It utilizes product-to-market channel partners to ensure an established market for the products of each spinout company. It utilizes company-to-financial markets channel partners to ensure adequate investment resources and aid in bringing the spin out companies to financial markets. It has a short time to realization for the formation of new ventures. It has a legal structure that reduces the risk for business related litigation.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 is a schematic diagram of a business model system according to the present invention;

FIG. 1A is block diagram of the composition of the management team 160 of FIG. 1;

FIG. 2 is a flow diagram of a method of executing the business model system of FIG. 1;

FIG. 3 is a schematic diagram of a method for developing an acceptable business plan model;

FIG. 4 is a schematic diagram of another business model system for implementing the present invention; and

FIG. 5 is a flow diagram of the method of using the business model system of FIG. 4.

### DETAILED DESCRIPTION OF THE INVENTION

The present invention is a method and a system for generating new businesses. By generating reusable intellectual property assets on an on-going basis and combining these assets with a strategic business model, viable spinout businesses can be devised and executed. Combined with an effective management team, outside intellectual property providers, ongoing access to human, intellectual and financial capital, membership in an economic environment, and technical and financial channel partners, these spinout businesses have a high probability of success in an international marketplace.

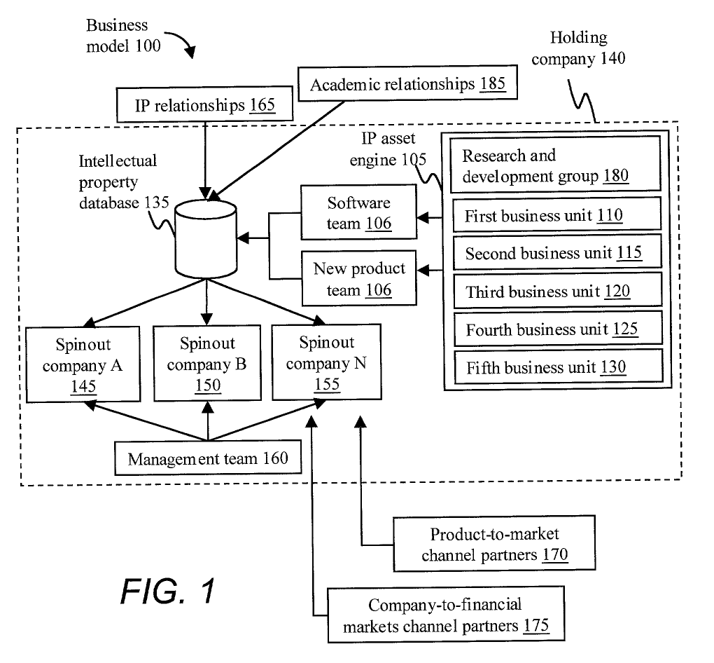

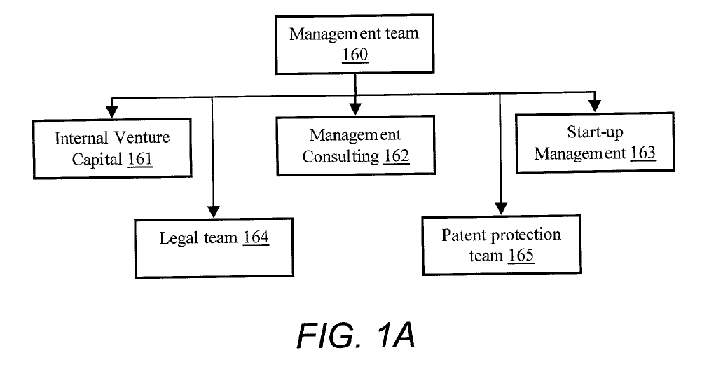

Referring to FIG. 1, business model 100 includes a holding company 140, IP relationships 165, academic relationships 185, product-to-market channel partners 170 and company-to-financial market channel partners 175. Holding company 140 includes an IP asset engine 105, an intellectual property database 135, a management team 160 and spinout company A 145, a spinout company B 150, and a spinout company N 155. IP asset engine 105 includes a research and development group 180, a first business unit 110, a second business unit 115, a third business unit 120, a fourth business unit 125, and a fifth business unit 130.

Holding company 140 represents the umbrella organization under which business model 100 operates. In one example, holding company 140 operates with approximately $200 million in seed capital that is used for the initial funding of spinout company A 145, spinout company B 150, and spinout company N 155. In addition to the spinout companies shown, there may be many more spinout companies. Holding company 140 provides the administrative and financial support infrastructure for the operation of IP asset engine 105, intellectual property database 135, management team 160, spinout company A 145, spinout company B 150, and spinout company N 155. Furthermore, holding company 140 establishes and coordinates IP relationships 165 with other companies, academic relationships 185 with academic institutions, relationships with product-to-market channel partners 170 and company-to-financial market channel partners 175.

IP asset engine 105 includes a group of business units 110, 115, 120, 125 and 130 and a research and development group 180. Each business unit 110-130 and the research and development group 180 generate intellectual property assets that are deposited in the intellectual property database 135. Each business unit 110-130 represents a specific area of technical and marketing domain expertise. In one example, first business unit 110 is an advanced telecommunications company; second business unit 115 is an air traffic control software development company, third business unit 120 is a commercial systems software development company, fourth business unit 125 is a global IP asset engineering development company, and fifth business unit 130 is a systems integration company. Other examples of business units include among others agricultural companies, mining, construction, manufacturing, transportation, communications, utilities, retail trade, wholesale trade, banking institutions, financial service companies, business services, management consulting, information technology services, law firms, educational institutions, health organizations and government organizations. IP asset engine 105 also includes a software development team 106 and a new product development team 107. Software development team 106 and new product development team 107 support all associated business units 110-130. Each business unit 110-130 within IP asset engine 105 generates its own profit and loss statement.

Intellectual property database 135 is a repository of all ideas, products, tools, processes, systems, and services generated by research and development group 180 and all business units 110-130 associated with IP asset engine 105. IP assets may also be acquired from third parties through IP relationships 165. Third parties include among others, other companies, universities, government institutions and individual inventors. Select intellectual property is drawn from intellectual property database 135 and used to create spinout company A 145, spinout company B 150, and spinout company N 155.

Research and development group 180 is composed of hardware and software product and technology developers and other technical personnel capable of supporting all business units 110-130 within IP asset engine 105. New ideas, products, tools, processes, systems, and services are developed within research and development group 180 and, when these have reached a sufficient level of development, they become new intellectual property which, is placed into intellectual property database 135 and thus become available to all business units 110-130 within IP asset engine 105.

Management team 160 is composed of a group of employees that are permanent employees of holding company 140. Referring to FIG. 1A, management team 160 includes the following components: an internal venture capital division 161 that evaluates the opportunities embodied in intellectual property database 135; a management consulting division 162 that decides how the technologies should be applied to the respective business model of the spinout company, for example company A 145; a start-up management team 163 composed of CEOs, COOs, CFOs, and the like, that begins the management process at the spinout company and eventually replace themselves with permanent management personnel within the spinout company; a legal team 164 to evaluate contracts and agreements; and a patent protection team 165 that is charged with managing intellectual property generated within the spinout company. IP relationships 165 includes relationships and agreements with third-party creators of intellectual property that is added to intellectual property database 135. These third-party creators of intellectual property include universities, research organizations, incubators, other companies and individuals. These entities may have marketable ideas and prototypes but lack the resources necessary to bring the products to market. Holding company 140 develops agreements with IP relationships 165 wherein holding company 140 leverages intellectual property developed within IP relationships 165 for use by the spinout companies 145-155.

Academic relationships 185 are established between holding company 140 and degree-granting academic institutions. As part of the academic relationships 185 arrangements graduate and postgraduate degrees are awarded for work carried out within business units 110-130 or spinout companies 145-155. These academic relationships 185 assist in creating and attracting the best human resources available globally to work on identified tasks that further the intellectual property or mission of holding company 140.

A reward system (not shown) is applied across all the stakeholders associated with the process, i.e., business units 110-130, research and development 180, spinout companies 145-155, holding company 140 and management team 160, to reinforce the desired behavior of the people and organizations who create the intellectual property, through to the people and organizations involved in spinning it out and commercializing it. In one example, the reward system includes equity being granted in the new enterprise, i.e., spinout companies 145-155, in the form of shares and options to the founder staff who have been involved in the process. The equity is provided on a prorated basis based on seniority and the time recorded against the involvement in the creation of the technology and the new enterprise.

Product-to-market channel partners 170 are established technology companies that serve as market conduits for the technologies and products of the business units 110-130 and the subsequent spinout companies 145-155. These product-to-market channel partners 170 are relatively large corporations with international recognition in given industries. Examples include, among others, Motorola, Intel and Lockheed Martin. By agreement, product-to-market channel partners 170 assist business units 110-130 and subsequently spinout companies 145-155 in bringing their technology to market by integrating technology from the spinout company with other products to create new products and distributing the new products through existing channels.

Company-to-financial markets channel partners 175 are established financial institutions that provide financial capital and aid in bringing the spinout companies 145-155 to financial markets. In addition to financial capital, company-to-financial markets channel partners 175 may also serve as client channels for the spinout companies 145-155. Examples of company-to-financial markets channel partners 175 include national and international banks, venture capital firms, investment management companies and private investors.

During the operation of business model 100, IP asset engine 105 produces hardware and software solutions, technology and products for specific clients and in doing so, produces intellectual property in the form of ideas, products, tools, processes, systems, and services which is placed within intellectual property database 135. Select intellectual property from intellectual property database 135 is chosen based on potential value in a given market, matched with an appropriate business model, and leveraged (“spun out”) into stand-alone companies, as shown by spinout companies 145-155. Spinout companies 145-155 typically contain higher value than the associated intellectual property within intellectual property database 135 on which it is based. The following criteria are used as the basis for making the determination as to whether intellectual property within intellectual property database 135 has adequate market potential to warrant the creation of a spinout company: 1) whether it has the ability to create $500 million annual revenue opportunity when positioned in the marketplace within a period of 10 years; 2) whether it has the ability to produce approximately $1 billion market capitalization from investors within a period of 10 years; and 3) whether it produces a positive cash flow within IP asset engine 105. This business process may include an “incubation process” whereby a specific component of intellectual property within intellectual property database 135 is marketed from within a respective business unit before the decision is made to create a separate spinout company using that intellectual property. This incubation process provides a test market vehicle for the intellectual property within intellectual property database 135 that provides a proof-of-concept and real market valuation for the intellectual property before it is spun out as part of a new company. Each product incubated in this way must meet the above criteria before being pushed into a stand-alone company.

Management team 160 provides the initial management expertise and legal guidance necessary to start each spinout company 145-155. Holding company 140, rather than outside investors, control the investment funds associated with each spinout company. Holding company 140 establishes cooperative agreements between the spinout companies and product-to-market channel partners 170 and company-to-financial markets channel partners 175. These agreements may involve financial, market or technology investment or assistance.

Business model 100, establishes a cooperative economic environment between each spinout company 145-155. Products, services and solutions generated by each spinout company 145-155 are provided to the intellectual property database 135 that is shared between each spinout company as well as the IP asset engine. In one example example, spinout company A 145 develops air traffic control visualization technology that is placed into the intellectual property database 135 that is shared with spinout company B 150 which develops this intellectual property together with other intellectual property, into a virtual online shopping tool. The effect of this business process is that spinout company A 145, spinout company B 150, and spinout company N 155 within holding company 140 become intellectual property providers for each other and customers of each other. This process requires that spinout company A 145, spinout company B 150, and spinout company N 155 agree to enter into ongoing access and contribution agreements with the holding company 140 and IP asset engine 105 for intellectual property contained in intellectual property database 135. This business environment allows for the combination of different IP assets and the creation of new IP assets or substitutions of one asset with another.

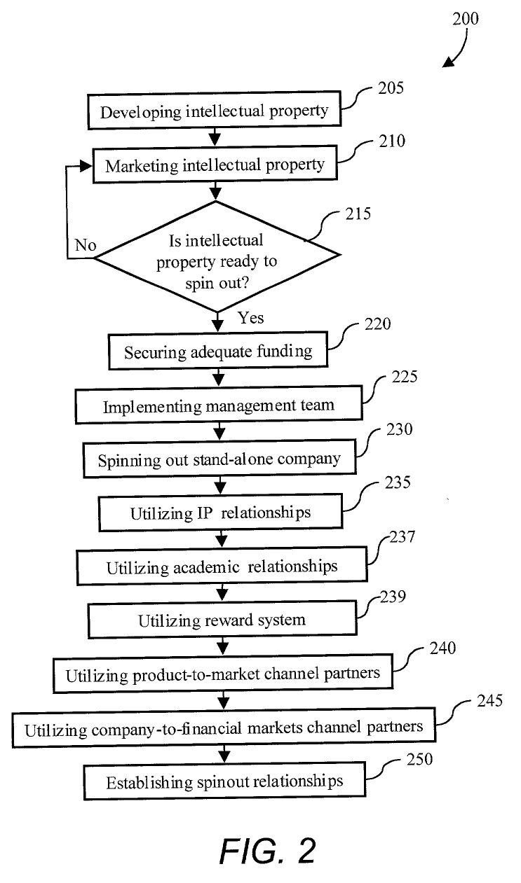

A method of executing business model 100 is now described with reference to FIG. 2.

Step 205: Developing Intellectual Property

In this step, IP asset engine 105 develops hardware and software solutions, technology, processes, tools, systems, and services for clients via its associated business units 110130 and research and development group 180. In addition, IP relationships 165 are utilized as a source of third-party intellectual property. These two sources together form the basis of intellectual property deposited within intellectual property database 135.

Step 210: Marketing Intellectual Property

In this step, business units 110-130 may incubate and market their respective business products while each business unit operates on a profit-and-loss basis.

Step 215: Is Intellectual Property Ready to Spin Out?

In this step, managers within IP asset engine 105 and holding company 140 decide if specific intellectual property within intellectual property database 135 is ready to spin out into a spinout company. In one example the spinout company is spinout company A 145. The decision of whether intellectual property within intellectual property database 135 has adequate market potential to warrant the creation of a spinout company is based on the following criteria: 1) whether it has the ability to create $500 million annual revenue opportunity when positioned in the marketplace within a 10 year period 2) whether it has the ability to produce approximately $1 billion market capitalization from investors within a 10 year period, and 3) whether it produces a positive cash flow within IP asset engine 105. If the answer to to criteria 1 & 2 above is yes, process 200 proceeds to step 220; if the answer is no, process 200 returns to step 210. Criterion 3 is used to govern the trade of between ongoing internal investment and value enhancement period.

Step 220: Securing Adequate Funding

In this step, managers within IP asset engine 105 and holding company 140 ensure that there is adequate funding to seed the development of the spinout company.

Step 225: Implementing Management Team

In this step, holding company 140 implements a temporary management team 160 to build structure at the spinout company. This is a broad-based team with multiple functions that ultimately seeks to replace itself at the spinout company with permanent management employees of the spinout company.

Step 230: Spinning Out Stand-Alone Companies

In this step, management within IP asset engine 105 spin out a stand-alone company under the financial umbrella of holding company 140. The financial risk for the spinout company is shared between IP asset engine 105, holding company 140, and spinout company.

Step 235: Utilizing IP Relationships

In this step, holding company 140 utilizes IP relationships 165 for intellectual property that may be useful in the spinout companies 145-155. Intellectual property from IP relationships 165 may also be used to create additional spinout companies.

Step 237: Utilizing Academic Relationships

In this step, holding company 140 utilizes academic relationships 185 to develop and attract human resources, facilities and expertise and to generate value within business units 110-130 or spinout companies 145-155. As part of the academic relationships 185 arrangements graduate and postgraduate degrees are awarded for work carried out within business units 110-130 or spinout companies 145-155. These academic relationships 185 assist in creating and attracting the best human resources available globally to work on identified tasks that further the intellectual property or mission of holding company 140.

Step 239: Utilizing a Reward System

In this step, holding company 140 utilizes a reward system to reinforce the desired behavior of the people and organizations that create intellectual property for use in intellectual property database 135. The reward system is applied to all individuals and organizations within holding company 140 as well as IP relationships 165, academic relationships 185, product-to-market channel partners 170, and company-to-financial channel partners 175.

Step 240: Utilizing Product-To-Market Channel Partners

In this step, holding company 140 utilizes the marketing resources of product-to-market channel partners 170 to aid in bringing the products of the spinout companies 145-155 to the markets.

Step 245: Utilizing Company-To-Financial Markets Channel Partners

In this step, holding company 140 utilizes the financial and market resources of company-to-financial markets channel partners 175 to aid in bringing the spinout companies 145-155 to financial markets.

Step 250: Establishing Spinout Relationships

In this step, managers of the spinout companies 145-155 join into mutually beneficial relationships. For example, spinout company A 145 may share intellectual property from intellectual property database 135 that is useful to spinout company B 150. Similarly spinout company B 150 may incorporate products and services of spinout company A 145 into its offerings.

The method of executing business model 100 outlined in process 200 is executed repeatedly for numerous spinout companies in multiple technology areas.

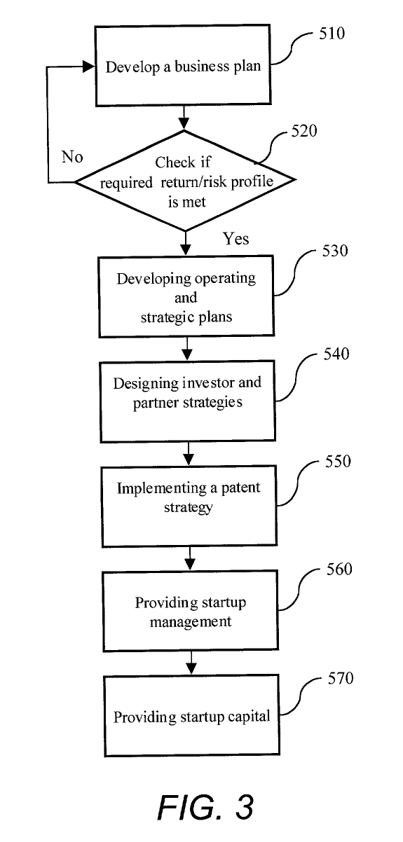

A method for management team 160 to develop an acceptable business plan model is now described with reference to FIG. 3.

Step 510: Developing a Business Model

In this step, managers of the holding company 140 and management team 160 develop a business plan model for the operation of the spinout company 145.

Step 520: Checking if Required Risk/Return Profile is Met

In this step, managers of holding company 140 and management team 160 determine if the required risk/return profile is met in order for the business model to be successful. Success of the business model is based on the following criteria: 1) whether it addresses an annual market of at least $500 million 2) whether it has the ability to produce in excess of $1 billion market capitalization from investors and 3) whether the level of investment and operational resource requirements within software engine 105 is adequate if the required risk/return profile is met proceed to next step 530. If the required risk/return profile is not met go back to step 510 and revise business plan model.

Step 530: Developing Operating and Strategic Plans

In this step, managers of holding company 140 and management team 160 develop operating and strategic plans for the spinout company. These plans include the coordination of software engine 105, IP relationships 165, academic relationships 185, company-to-financial markets channel partners 175, product-to-market channel partners 170, and management team. The operating and strategic plans also include the determination of markets that are viable for the available intellectual property.

Step 540: Designing Investor and Partner Strategies

In this step, managers of holding company 140 and management team 160 design investor and partner strategies that will facilitate the successful operation of the business plan model for the spinout company. These partnerships include software engine 105, IP relationships 165, academic relationships 185, company-to-financial markets channel partners 175, product-to-market channel partners 170, and management team 160.

Step 550: Implementing a Patent Strategy

In this step, managers of holding company 140 and management team 160 implement a patent strategy for the protection of the available intellectual property within intellectual property database 135 or the business model of the spinout company 145-155. These strategies include patenting of intellectual property, publishing of intellectual property, holding intellectual property as trade secrets, and licensing of various intellectual property assets. These strategies are specific for each spinout company 145-155.

Step 560: Providing Startup Management

In this step, managers of holding company 140 and management team 160 provide a startup management group from within the management team 160 for the spinout company. The startup management group is trained to provide all necessary services to the spinout company and includes an executive team, human resources, a legal team, a contract team, and a patent team.

Step 570: Providing Startup Capital

In this step, managers of holding company 140 and management team 160 provide startup capital to the spinout companies 145-155. This capital may be raised from internal funds of holding company 140 or secured from outside investors.

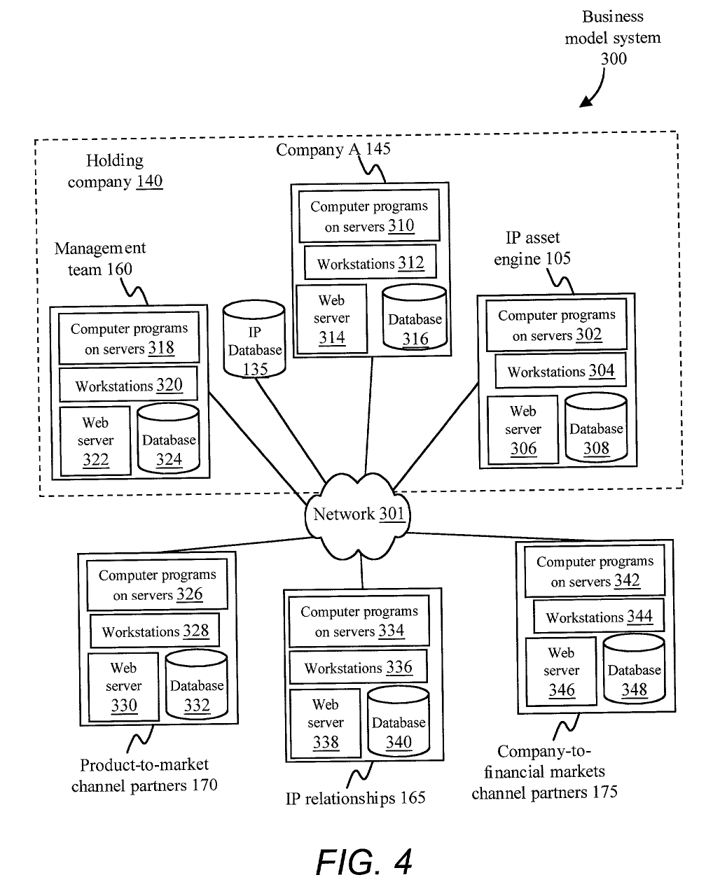

Referring to FIG. 4, another embodiment of a business model system 300 of the present invention includes holding company 140, product-to-market channel partners 170, IP relationships 165, company-to-financial markets channel partners 175, and network 301 which connects all of the above mentioned entities. Holding company 140 includes IP asset engine 105, spinout company A 145, IP Database 135 and management team 160.

Holding company 140, IP asset engine 105, spinout company A 145, management team 160, IP Database 135, product-to-market channel partners 170, IP relationships 165, company-to-financial markets channel partners 175 are as were described above in FIG. 1. Furthermore, IP asset engine 105 includes computer programs on servers 302, workstations 304, a database 308, and a web server 308. Computer programs on servers 302 are electrically connected to workstations 304, web server 306 is electrically connected to network 301, and database 308 is electrically connected to web server 306, computer programs on servers 302, and workstations 304. Computer programs on servers 302, workstations 304, web server 306, and database 308 are electrically and logically connected on a common local area network (LAN)(not shown). IP asset engine 105, spinout company A 145, management team 160, product-to-market channel partners 170, IP relationships 165, and company-to-financial markets channel partners 175 are all electrically and logically connected to the network 301. Similar to IP asset engine 105, management team 160, company A 145, product-to-market channel partners 170, IP relationships 165 and company-to-financial markets channel partners 175 include computer programs on servers 318, 310, 326, 334, 342, workstations 320, 312, 328, 336, 344, web servers 322, 314, 330, 338, 346, and databases 324, 316, 332, 340, 348, respectively.

Network 301 may be a private intranet such as a Virtual Private Network (VPN) or the global TCP-IP Internet. Network 301 provides a primary means of communication between the above mentioned business segments. Further, communication between business segments may occur over fixed telephone lines, wireless telephones, or other telecommunication infrastructures.

Computer programs on servers 302, 318, 310, 326, 334, 342 are software development tools, the type of which depends on the development task. For example, visualization software may be used to develop air traffic control virtual reality training programs. Workstations 304, 312, 320, 328, 336, 344 are computer processors, the type of which depends on the development task. For example, workstations 304 may be Silicon Graphics processors for high-end graphics development, or PCs for less resource-intensive tasks. Web servers 306, 314, 322, 330, 338, 346 are processors with the necessary hardware and software to connect IP asset engine 105, company A 145, management team 160, product-to-market channel partners 170, IP relationships 165 and company-to-financial markets channel partners 175 to the network 301, respectively. Databases 308, 316, 324, 332, 340, 348 contain relational database tables to allow the storing and retrieval of stored data.

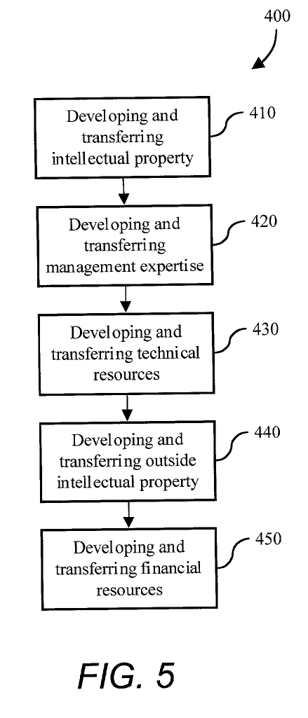

A method of using business model system 300 to execute business model 100 is now described with reference to FIG. 5.

Step 410: Developing and Transferring Intellectual Property

In this step, IP asset engine 105 develops intellectual property within intellectual property database 135 using workstations 304, computer programs on servers 302, and database 308. Intellectual property 135 is then transferred to spinout company A 145 via web server 306 and network 301. Intellectual property within intellectual property database 135 is received by web server 314 and used and marketed within spinout company A 145 using computer programs on servers 310, workstations 312, and database 316.

Step 420: Developing and Transferring Management Expertise

In this step, management team 160 assists spinout company A 145 in building a business by supplying expertise developed in the form of software developed on workstations 320 using computer programs on servers 318 and stored on database 324. This expertise is transferred to spinout company A via web server 322 and network 301 and utilized within spinout company A 145 using computer programs on servers 310, workstations 312, and database 316.

Step 430: Developing and Transferring Technical Resources

In this step, product-to-market channel partners 170 assist spinout company A 145 in building a business by supplying technical resources developed and stored in the form of software developed on workstations 328 using computer programs on servers 326 and stored on database 332. These resources are transferred to spinout company A via web server 330 and network 301 and utilized within spinout company A 145 using computer programs on servers 310, workstations 312, and database 316.

Step 440: Developing and Transferring Outside Intellectual Property

In this step, IP relationships 165 supply third-party developed intellectual property to intellectual property database 135 from sources apart from IP asset engine 135. Intellectual property from these sources is developed on workstations 336 using computer programs on servers 334 and stored on database 340. Intellectual property from within intellectual property database 135 is then transferred to spinout company A 145 via web server 338 and network 301 and utilized within spinout company A 145 using computer programs on servers 310, workstations 312, and database 316.

Step 450: Developing and Transferring Financial Resources

In this step, company-to-financial market channel partners 175 assist spinout company A 145 in building a business by supplying financial resources developed and stored in the form of software developed on workstations 344 using computer programs on servers 342 and stored on database 348. These resources are transferred to spinout company A via web server 346 and network 301 and utilized within spinout company A 145 using computer programs on servers 310, workstations 312, and database 316. In one example, spinout company A 145 is a language translation company. Holding company 140 developed certain technology (intellectual property) for automatic translation from Asian language to English. This technology was developed under a contract for a government agency. The developed intellectual property includes among others a translation engine, a parser, lexicons, and translator tools. The management team of holding company 140 studied numerous business models including selling a shrink-wrapped translation product and providing an online translation service which could leverage this technology. Finally, holding company 140 combined its language translation intellectual property with IP provided from a third company by forming an IP relationship 165 and created the spinout company A 145. Spinout company A 145 has its own management team and utilizes holding company's 140 marketing and financial relations. Seed financing was initially provided by holding company 140 and a first group of investors. Additional funding for setting up spinout company A145 as a separate entity was provided by a strategic investor who had participated in the first round of seed financing.

In another example, spinout company A 145 is a simulation learning company. Holding company 140 developed simulation learning intellectual property for addressing the needs of a client company in a certain market segment. The initial addressable market segment of the client company was the aerospace industry. Holding company 140 then created a new business, i.e., spinout company A 145, utilizing the simulation learning IP, to provide a simulated job learning environment for any type of corporation. Spinout company A 145 is a 100% subsidiary of holding company 140. Holding company 140 will spin out the new business as a separate operating company and assume a stake in equity, as part of the reward infrastructure.

What is claimed is:

1. A method of generating a new enterprise comprising the steps of:
forming a holding company comprising of previously existing enterprises;
developing intellectual property(IP) assets within said existing enterprises;
depositing said IP assets in a common database owned by said holding company;
developing new products and market opportunities for at least one of said developed IP assets within at least one of said existing enterprises;
deciding whether to form said new enterprise based on said developed new products and market opportunities for said at least one of IP assets;
after the decision is made to form said new enterprise securing financing for the formation of said new enterprise;
providing management resources for managing said new enterprise; and
executing the formation of said new enterprise.

2. The method of claim 1 further comprising acquiring intellectual property assets from companies other than the holding company for developing new products and market opportunities.

3. The method of claim 1 wherein said holding company further comprises financial asset companies and wherein said financial asset companies provide the financing for the formation of said new enterprise.

4. The method of claim 3 wherein said financial asset companies comprise banking institutions, venture capital firms, financial investment companies and private investors.

5. The method of claim 1 wherein said holding company further comprises a management team and wherein said management team provides said management resources for said new enterprise.

6. The method of claim 5 wherein said management team comprises management consulting resources.

7. The method of claim 5 wherein said management team comprises legal resources.

8. The method of claim 5 wherein said management team comprises patent protection resources.

9. The method of claim 5 wherein said management team comprises start-up company management resources.

10. The method of claim 1 wherein said existing enterprises comprise at least one of agricultural companies, mining, construction, manufacturing, transportation, communications, utilities, retail trade, wholesale trade, banking institutions, financial service companies, business services, management consulting, information technology services, law firms, educational institutions, health organizations and government organizations.

11. The method of claim 1 wherein said step of deciding whether to form a new enterprise comprises:
evaluating the ability of said new enterprise to generate $500 million annual revenues within a period of ten years;
evaluating the ability of said new enterprise to generate $ one billion market capitalization within a period of ten years; and
evaluating the ability of said new enterprise to generate positive cash flow.

12. The method of claim 1 further comprising establishing cooperative agreements between said holding company and product-to-market channel partners.

13. The method of claim 12 wherein said product-to-market channel partners comprise at least one of international and national operating corporations.

14. The method of claim 1 generating more than one new enterprise on a repeatable basis.

15. The method of claim 14 wherein said existing enterprises and said new enterprises agree to cooperation arrangements regarding said IP assets contained in said common database as well as access to IP assets developed in the future.

16. The method of claim 1 further comprising establishing relationships between said holding company and academic institutions wherein said holding company provides training opportunities to students of said academic institutions.

17. The method of claim 16 wherein said academic institutions grant academic degrees to employees and trainees of said holding company for scientific, business and technical development work performed in said holding company.

18. The method of claim 1 further comprising utilizing a reward system for reinforcing developing of intellectual property assets by personnel and enterprises of said holding company.

19. The method of claim 1 further comprising establishing financing arrangements for said new enterprise between said holding company and financial asset companies.

20. A business system generating a new enterprise, the system comprising:
a holding company comprising of existing enterprises;
intellectual property(IP) assets developed within said existing enterprises;
an IP database contained within said holding company for depositing said IP assets;
new product and new market development teams for developing new products and market opportunities for at least one of said developed IP assets within at least one of said existing enterprises;
financial assets for financing the formation of said new enterprise; and
management resources for managing said new enterprise.

21. The business system of claim 20 further comprising a network system connecting said existing enterprises, holding company, IP database, financial assets new product development team, new market development team, management team and said new enterprise.

22. The business system of claim 20 further comprising intellectual property assets acquired from companies other than the holding company for developing new products and market opportunities.

23. The business system of claim 20 wherein said holding company further comprises financial asset companies and wherein said financial asset companies provide said financial assets for financing the formation of said new enterprise.

24. The business system of claim 23 wherein said financial asset companies comprise banking institutions, venture capital firms, financial investment companies and private investors.

25. The business system of claim 20 wherein said holding company comprises a management team and wherein said management team provides said management resources for said new enterprise.

26. The business system of claim 25 wherein said management team comprises management consulting resources.

27. The business system of claim 25 wherein said management team comprises legal resources.

28. The business system of claim 25 wherein said management team comprises patent protection resources.

29. The business system of claim 25 wherein said management team comprises startup company management resources.

30. The business system of claim 20 wherein said existing enterprises comprise at least one of agricultural companies, mining, construction, manufacturing, transportation, communications, utilities, retail trade, wholesale trade, banking institutions, financial service companies, business services, management consulting, information technology services, law firms, educational institutions, health organizations and government organizations.

31. The business system of claim 20 further comprising cooperative agreements between said holding company and product-to-market channel partners.

32. The business system of claim 31 wherein said product-to-market channel partners comprise international and national operating corporations.

33. The business system of claim 20 generating more than one new enterprise on a repeatable basis.

34. The business system of claim 33 wherein said existing enterprises and said new enterprises agree to cooperation arrangements regarding said IP assets contained in said common database.

35. The business system of claim 20 further comprising relationships between said holding company and academic institutions wherein said holding company provides training opportunities to students of said academic institutions.

36. The business system of claim 35 wherein said academic institutions grant academic degrees to employees and trainees of said holding company for scientific, business and technical development work performed in said holding company.

37. The business system of claim 20 further comprising a reward system for reinforcing developing of intellectual property assets by personnel and enterprises of said holding company.

38. The business system of claim 20 further comprising financing arrangements between said holding company and financial asset companies for financing said new enterprise.
